(19) United States
(12) Patent Application Publication
(10) Pub. No.: US 2025/0343923 A1
(43) Pub. Date: Nov. 6, 2025

(54) METHOD, DEVICE, AND COMPUTER PROGRAM FOR IMPROVING MULTITRACK ENCAPSULATION OF POINT CLOUD DATA

(71) Applicant: CANON KABUSHIKI KAISHA, Tokyo (JP)

(72) Inventors: Franck DENOUAL, SAINT DOMINEUC (FR); Frédéric MAZE, LANGAN (FR); Naël OUEDRAOGO, MAURE DE BRETAGNE (FR); Lionel TOCZE, SAINT DOMINEUC (FR)

(21) Appl. No.: 18/854,036

(22) PCT Filed: Apr. 3, 2023
(86) PCT No.: PCT/EP2023/058672

§ 371 Date: Oct. 3, 2024

(30) Foreign Application Priority Data
Apr. 5, 2022 (GB) 2204997.7

(51) Int. Cl. H04N 19/174; H04N 19/172; H04N 19/597; H04N 19/70

(52) U.S. Cl. CPC H04N 19/174; H04N 19/172; H04N 19/597; H04N 19/70

(57) ABSTRACT

According to some embodiments of the disclosure, it is provided a method for encapsulating a bit-stream in a media file comprising different tracks, the bit-stream comprising point cloud data, the point cloud data comprising slice-based point cloud frames, the slices of the point cloud frames comprising data units of different types. After having obtained first data units of a first slice of one point cloud frame and second data units of a second slice of the point cloud frame, each of the obtained first and second data units is encapsulation encapsulated in a track of the media file, as a function of a type of the data unit. At least one item of information characterizing the relative position in the tracks of the media file of the first data units with regard to the second data units is obtained and encapsulated in the media file.

### CROSS-REFERENCE TO RELATED APPLICATIONS

This application is the National Phase application of PCT/EP2023/058672, which was filed on Apr. 3, 2023 and which claims priority to United Kingdom Patent Application No. GB 2204997.7, entitled “METHOD, DEVICE, AND COMPUTER PROGRAM FOR IMPROVING MULTITRACK ENCAPSULATION OF POINT CLOUD DATA,” which was filed on Apr. 5, 2022 and which is incorporated herein by reference in its entirety.

### FIELD OF THE DISCLOSURE

The present disclosure relates to encapsulation of data, in particular of point cloud data, in a standard and interoperable format, for example to store or transmit slice-based point cloud frames of 3D points, as a set of tracks.

### BACKGROUND OF THE DISCLOSURE

The Moving Picture Experts Group (MPEG) is standardizing the compression and storage of point cloud data (also called volumetric media data) information. Point cloud information consists in sets of 3D points with associated attribute information such as colour, reflectance, and frame index.

On the first hand, MPEG-I Part-9 (ISO/IEC 23090-9) specifies Geometry-based Point Cloud Compression (G-PCC) and specifies a bit-stream syntax for point cloud information. According to MPEG-I Part-9, a point cloud is an unordered list of points comprising geometry information, optional attributes, and associated metadata. Geometry information describes the location of the points in a three-dimensional Cartesian coordinate system. Attributes are typed properties of each point, such as colour or reflectance. Metadata are items of information used to interpret the geometry information and the attributes. The G-PCC compression specification (MPEG-I Part-9) defines specific attributes like frame index attribute or frame number attribute, with a reserved attribute label value (3 to indicate a frame index and 4 to indicate a frame number attribute), being recalled that according to MPEG-I Part-9, a point cloud frame is set of points at a particular time instance. A point cloud frame may be partitioned into one or more ordered sub-frames, tiles, or slices. A sub-frame is a partial representation of a point cloud frame consisting of points with the same frame number or frame index attribute value. For example, a sub-frame may be a set of points with their attributes within a point cloud frame that share common acquisition, capture, or rendering time. As another example, a sub-frame may be a set of points with their attributes within a point cloud frame that were successively acquired or capture during a given time range or should be rendered in a given time range. Yet as another example, a sub-frame may be a set of points with their attributes within a point cloud frame that were acquired according to a laser shot direction or corresponding to a part of the scanning path of the 3D sensor. Still in MPEG-I Part-9, a point cloud frame is indicated by a FrameCtr variable, possibly using a frame boundary marker data unit or parameters in some data unit header (a frame_ctr_lsb syntax element).

It is recalled that a tile is a set of slices identified by a common slice tag syntax element value whose geometry is contained within a bounding box that may be specified in a tile inventory data unit. Each tile consists of a single bounding box and an identifier (tileId). Tile information is not used by the decoding processes specified in ISO/IEC 23090-9. A slice corresponds to geometry and attributes of a part of a coded point cloud frame or of an entire coded point cloud frame. Every slice should include at least one geometry data unit (GDU) that codes the slice geometry and attribute data units (ADUs) or defaulted attribute data units (DUs) that code the slice attributes. A slice is identified by the GDU slice_id. ISO/EC 23090-9 specifies the slice decoding process as a four step process:
decoding of the points within the slice,
decoding of the default attributes, if any,
decoding of the point attributes, if any, and
offsetting and scaling of point positions.

On the second hand, MPEG-I Part-18 (ISO/IEC 23090-18) specifies a media format that makes it possible to store and to deliver geometry-based point cloud compression data. It is also supporting flexible extraction of geometry-based point cloud compression data at delivery and/or decoding time. According to MPEG-I Part-18, the point cloud frames are encapsulated in one or more G-PCC tracks, a sample in a G-PCC track corresponding to a single point cloud frame. Each sample comprises one or more G-PCC units which belong to the same presentation time. A G-PCC unit is one type-length-value (TLV) encapsulation structure containing at least one of a Sequence Parameter Set (SPS), a Geometry Parameter Set (GPS), an Attribute Parameter Set (APS), a tile inventory, a frame boundary marker, a Geometry Data Unit (GDU), an attribute data unit (ADU), a defaulted attribute data unit, a frame-specific attribute property (FSAP) data unit, and a user-data data unit. The syntax of TLV encapsulation structure is defined in Annex B of ISO/IEC 23090-9.

While the ISO Base Media file format has proven to be efficient to encapsulate point cloud data, there is a need to improve encapsulation efficiency, in particular to improve multitrack encapsulation of slice-based point cloud frames of 3D points (i.e. point cloud frames comprising at least one slice).

### SUMMARY OF THE DISCLOSURE

The present disclosure has been devised to address one or more of the foregoing concerns.

In this context, there is provided a solution for improving encapsulation of point cloud data.

According to a first aspect of the disclosure there is provided a method of encapsulating a bit-stream in a media file comprising different tracks, the bit-stream comprising point cloud data, the point cloud data comprising slice-based frames, the slices of the frames comprising data units of different types, the method comprising:
obtaining first data units of a first slice of one frame;
for each of the obtained first data units, encapsulating the first data unit in a track of the media file, the track being selected as a function of a type of the first data unit;
obtaining second data units of a second slice of the frame;
for each of the obtained second data units, encapsulating the second data unit in a track of the media file, the track being selected as a function of a type of the second data unit;
obtaining at least one item of information characterizing the relative order, in a sample of a track, of a data unit of the first slice with regard to a data unit of the second slice; and
encapsulating the obtained at least one item of information in the media file.

Accordingly, the method of the disclosure makes it possible to describe encapsulated data units of a bit-stream comprising slice-based point cloud data frames, enabling a parser to generate a bit-stream with data units properly ordered.

According to some embodiments, at least one of the obtained at least one item of information is encapsulated in a first track of the different tracks of the media file as a sample group.

Still according to some embodiments, at least one of the obtained at least one item of information is encapsulated in each track of the different tracks of the media file.

Still according to some embodiments, the at least one item of information encapsulated in each track of the different tracks of the media file is a slice separator.

Still according to some embodiments, the at least one item of information comprises a description of a structure of data units within a sample, each data unit being associated with slice information.

Still according to some embodiments, the first track has a reference to the other tracks of the different tracks and the at least one item of information comprises a number of consecutive data units, for each slice in a sample, for the first track and for the referenced tracks.

Still according to some embodiments, the at least one item of information further comprises the number of slices in the sample.

Still according to some embodiments, the media file complies with an ISOBMF format.

According to a second aspect of the disclosure there is provided a method of parsing a media file comprising encapsulated point cloud data, the point cloud data comprising slice-based frames, the slices of the frames comprising data units of different types, the data units being encapsulated in the media file in different tracks as a function of their type, the method comprising:
obtaining, from the media file, at least one item of information characterizing the relative order, in a sample of a track, of a data unit belonging to a first slice with regard to a data unit belonging to a second slice,
obtaining a first set of at least one first data unit from a first track of the different tracks based on the at least one item of information, the data units of the first set belonging to the first slice;
obtaining a second set of at least one second data unit from a second track of the different tracks based on the at least one item of information, the second track being different from the first track and the data units of the second set belonging to the first slice, and
concatenating the data units of the first set and the data units of the second set so that the data units of the first set and the data units of the second set are contiguous.

Accordingly, the method of the disclosure makes it possible to parse slice-based point cloud frames encapsulated in a multitrack media file to generate a bit-stream with data units properly ordered. It is to be noted here that a data unit belonging to a slice of a track and a data unit belonging to a corresponding slice of another track belong to the same slice in the bit-stream.

Still according to some embodiments, the method further comprises obtaining a third set of at least one third data unit from the first track based on the at least one item of information, the data units of the third set belonging to the second slice, the second slice being different from the first slice and following the first slice, the data units of the first set and the data units of the third set belonging to a same sample, the data units of the third set being concatenated after the data units of the first set and the data units of the second set in the generated bit-stream.

Still according to some embodiments, at least one of the obtained at least one item of information is encapsulated in the first track of the media file as a sample group.

Still according to some embodiments, the at least one item of information is a slice separator.

Still according to some embodiments, the first track has a reference to the other tracks of the different tracks and the at least one item of information comprises a number of consecutive data units for each slice in a sample for the first track and for the referenced tracks.

Still according to some embodiments, the media file complies with an ISOBMF format.

Still according to some embodiments, the first track has a type indicating a geometry track and the other tracks of the different tracks have a type indicating attribute tracks.

According to another aspect of the disclosure there is provided a device comprising a processing unit configured for carrying out each of the steps of the method described above.

This aspect of the disclosure has advantages similar to those mentioned above.

At least parts of the methods according to the disclosure may be computer implemented. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit”, “module” or “system”. Furthermore, the present disclosure may take the form of a computer program product embodied in any tangible medium of expression having computer usable program code embodied in the medium.

Since the solution of the present disclosure can be implemented in software, the solution of the present disclosure can be embodied as computer readable code for provision to a programmable apparatus on any suitable carrier medium. A tangible carrier medium may comprise a storage medium such as a floppy disk, a CD-ROM, a hard disk drive, a magnetic tape device or a solid state memory device and the like. A transient carrier medium may include a signal such as an electrical signal, an electronic signal, an optical signal, an acoustic signal, a magnetic signal or an electromagnetic signal, e.g. a microwave or RF signal.

### BRIEF DESCRIPTION OF THE DRAWINGS

Some embodiments of the disclosure will now be described, by way of example only, and with reference to the following drawings in which:

FIG. 1 illustrates an example of a system wherein the invention can be implemented;

FIG. 2 illustrates an example of encapsulating a bit-stream in several tracks of a media file and of parsing the latter to generate a bit-stream compliant with a given format such as MPEG-I Part-9;

FIG. 3 illustrates a first example of the structure of a frame of a sequence of frames of a G-PCC bit-stream to be encapsulated and parsed, wherein all the slices of the point cloud frames have the same structure;

FIG. 4 illustrates a second example of the structure of a frame of a sequence of frames of a G-PCC bit-stream to be encapsulated and parsed, wherein all the slices of the point cloud frames do not have the same structure;

FIG. 5 illustrates an example of steps of an encapsulation process according to some embodiments of the invention, making it possible to encapsulate point cloud data in multiple tracks in an interoperable way for a parser to generate compliant G-PCC bit-streams;

FIG. 6 illustrates an example of steps of a parsing process according to some embodiments of the invention;

FIG. 7 illustrates an example of adding static or semi-static indication in a multi-track media file encapsulating slice-based point cloud frames to help a parser to reconstruct a bit-stream complying with a predetermined format, for example to reconstruct a G-PCC bit-stream;

FIG. 8 illustrates an example of adding dynamic indication in a multi-track media file encapsulating slice-based point cloud frames to help a parser to reconstruct a bit-stream complying with a predetermined format, for example to reconstruct a G-PCC bit-stream;

FIG. 9 illustrates an example of adding slice separators in a multi-track media file encapsulating slice-based point cloud frames to help a parser to reconstruct a bit-stream complying with a predetermined format, for example to reconstruct a G-PCC bit-stream; and

FIG. 10 schematically illustrates a processing device configured to implement at least one embodiment of the present disclosure.

### DETAILED DESCRIPTION OF THE DISCLOSURE

The inventors have observed that data units of slice-based point cloud frames of a bit-stream should be encapsulated according to particular constraints or with additional metadata to enable a parser to generate a usable bit-stream complying with a given format, that is to say a bit-stream comprising data units properly ordered.

According to some embodiments of the disclosure, data units of slice-based point cloud frames of a bit-stream are encapsulated in a multitrack media track in such a way that a parser can parse the encapsulated data units in order to provide a bit-stream complying with a predetermined format, for example a bit-stream complying with MPEG-I Part-9.

Still according to some embodiments of the disclosure, additional metadata are provided in tracks of a media file, for example in G-PCC tracks, to enable identifying data unit of a given slice to data units of another slice. Such additional metadata may comprise an end of slice indication within a track or a description of data unit organization within a slice, such organization being static or dynamic.

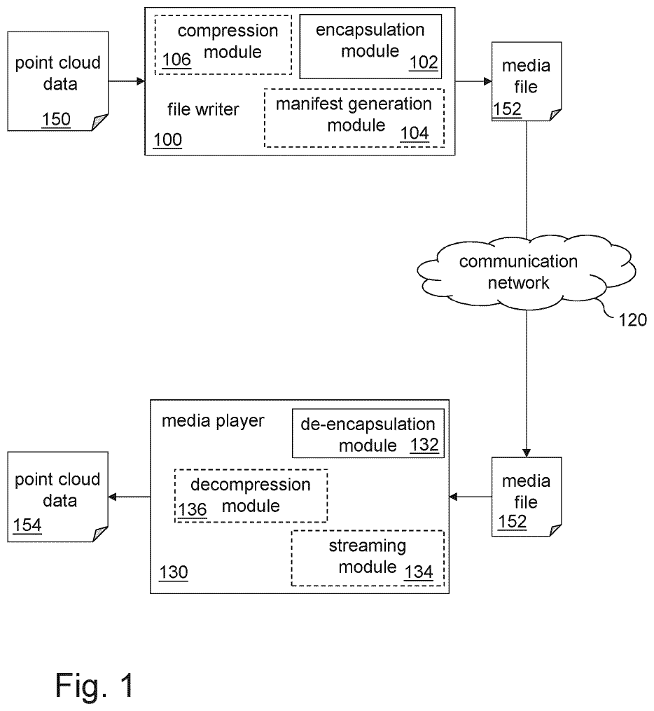

FIG. 1 illustrates an example of a system wherein the invention can be implemented. More precisely, the invention may be used in a media file writer such as media file writer 100 or in a media player such as media player 130 or in both.

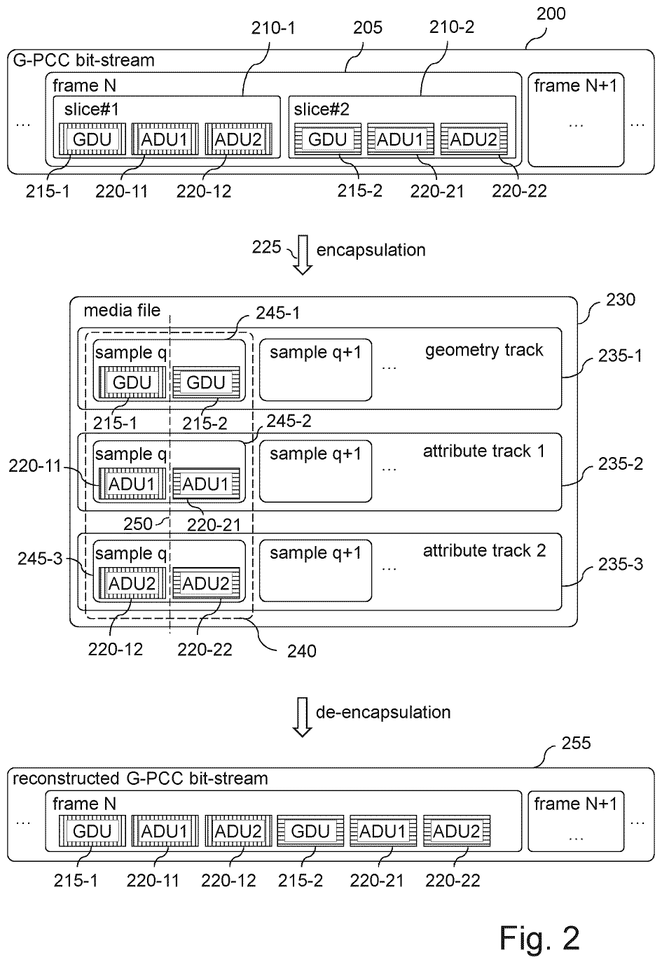

As illustrated, media file writer 100 takes point cloud data (or volumetric data), such as point cloud data 150, as input. Point cloud data 150 may be obtained from a 3D sensor, as described by reference to FIG. 2. The point cloud data may be received as uncompressed raw data or as a compressed bit-stream, for example a compressed bit-stream complying with the MPEG-I Part-9 standard. Media file writer 100 comprises encapsulation module 102.

Media file writer 100 may be connected, via a network interface (not represented), to a communication network 120 to which may also be connected, via a network interface (not represented), media player (or reader) 130 comprising a de-encapsulation module 132.

Media file writer 100 may be used to serve media files, for example using a protocol for dynamic adaptive streaming on HTTP like DASH (Dynamic Adaptive Streaming over HTTP) or HTTP Live Streaming. These protocols require a streaming manifest, such as a Media Presentation Description (MPD), or a playlist. When used to stream encapsulated media content, media file writer 100 may contain a manifest generation module such as manifest generation module 104. Media file writer 100 may also contain a compression module such as compression module 106 to compress the input point cloud data into a compressed bit-stream, for example using a point cloud compression algorithm like the one described in MPEG-I Part-9.

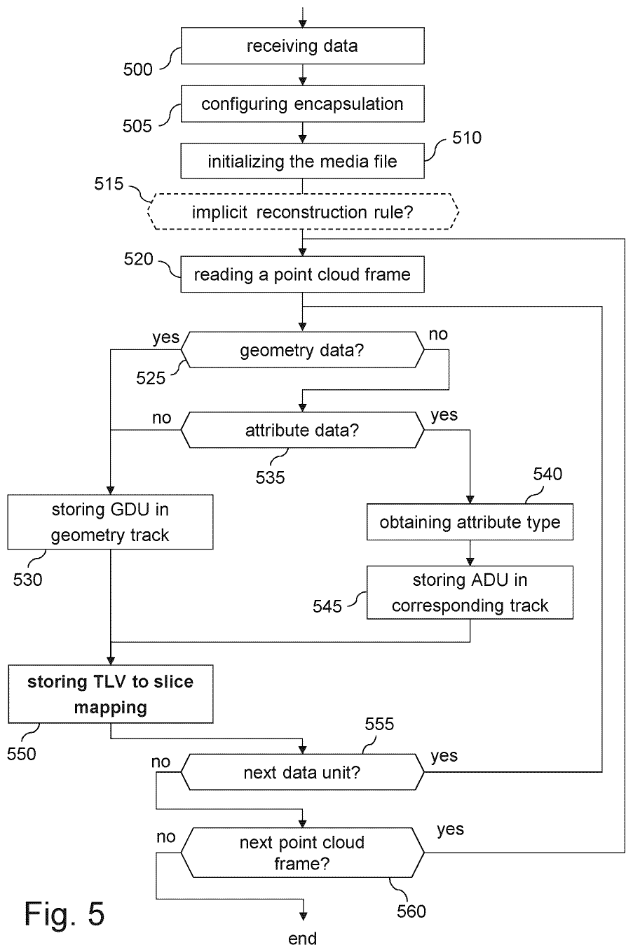

Encapsulation module 102 may encapsulate received point cloud data according to an ISOBMFF-based format like MPEG-I Part-18, for interoperability purposes, in order to generate a media file like media file 152 that may be stored for later use by a player or by an image analysis tool or that may be transmitted to a media player or streaming client. The encapsulation process carried out in encapsulation module 102 is further described in reference to FIG. 5.

Media file writer 100 may be controlled and parameterized by a user, for example through a graphical user interface or by an application, for example by application code or scripting. To process compressed point cloud data, for example to process a bit-stream of compressed point cloud data complying with MPEG-I Part-9, encapsulation module 102 may contain a G-PCC unit parser that can read the header of G-PCC units, for example to determine the length (e.g. in bytes, like the tlv_num_payload_bytes syntax element) of the data corresponding to the unit or the unit type (e.g. the tlv_type syntax element). The G-PCC unit parser may also be able to parse header information for some G-PCC units, like for example the attribute header (to obtain its type) and may also be able to parse parameter sets to obtain general information on the bit-stream. To process uncompressed point cloud data, for example data obtained directly from a 3D sensor, encapsulation module 102 may contain a point cloud data parser that can read the point positions and their attributes directly from the captured raw data (e.g. a .ply or .pcd file parser). The media writer may be embedded in a recording device, in a multi-sensor camera device, on a vehicle embedding 3D sensors or be part of software tools in a studio where volumetric data is acquired.

Media file 152 may consist in a single media file or in a set of media segment files, for example as ISOBMFF segments (ISO base media file containing one or more segment(s)). The media file may be a fragmented file, for example for live acquisition or capture and encapsulation or live (or low-latency) streaming. It may comply with the ISOBMFF standard or to standard specifications derived from ISOBMFF (e.g. MPEG-I Part-18).

Media player (or reader) 130 may be a streaming client, the streaming features being handled by a streaming module like streaming module 134, for example implementing a DASH or HLS client, for requesting a media file such as media file 152 and for adapting the transmission parameters. The media player may also implement, an RTP or RTC Web client, especially for live transmission, that may experiment transmission losses. Media player 130 may also contain a decompression module 136 taking as input a bit-stream representing compressed point cloud data, for example a bit-stream complying with MPEG-I Part-9, and generating point cloud data (or volumetric data) for rendering or analysis. Media file 152 may be read from a storage location or streamed using the streaming module 134. The data may be read at once or by chunks, segments, or fragments and provided to de-encapsulation module (or parsing module) 132.

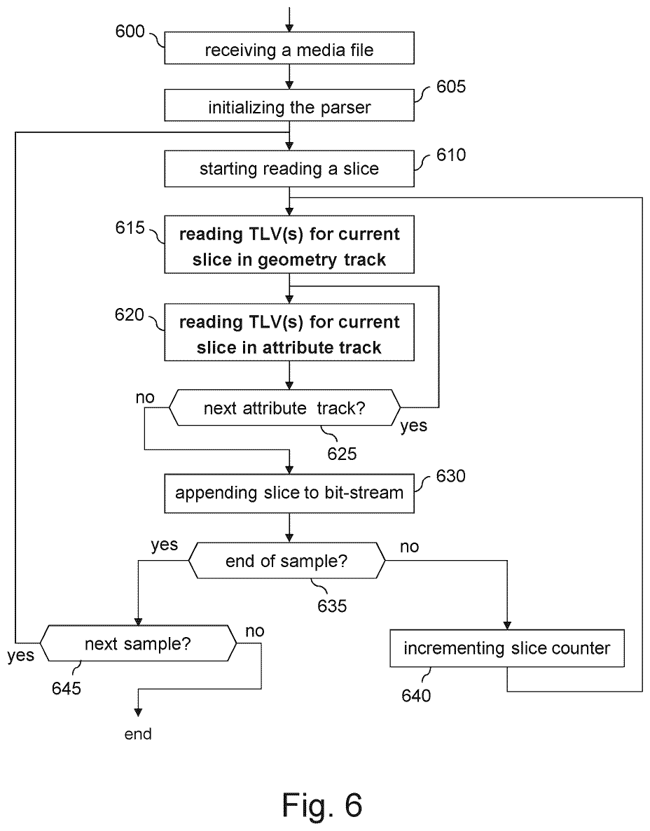

De-encapsulation module (or parsing module) 132 then extracts the, or a subset of, encapsulated point cloud data, depending on the player configuration or on the choices from a user or on the parameters of an application using the media player. The extracted point cloud data may result in a bit-stream such as a bit-stream complying with MPEG-I Part-9. In such a case, the bit-stream is provided to a decompression module (an external decompression module or an internal decompression module, e.g. internal decompression module 136) for the reconstruction of the point cloud data 154 for usage by a user or application (for example visualization or analysis). The parsing process is further described in reference to FIG. 6. A media player may be embedded in a display device (e.g. a smartphone, tablet, PC, vehicle with multimedia screen, etc. or software tools in a studio for volumetric data production).

FIG. 2 illustrates an example of encapsulating a bit-stream in several tracks of a media file and of parsing the latter to generate a bit-stream compliant with a given format such as MPEG-I Part-9. The bit-stream to be encapsulated may be a G-PCC bit-stream and the encapsulated media file may be an ISOBMFF media file that tracks are, for example ISO/IEC 23090-18 ‘gpc1’ and/or ‘gpcg’ tracks. It is noted that the media data of the bit-stream to be encapsulated may be tiled media data, possibly encapsulated as a ‘gpcb’ tile base track referencing G-PCC tile tracks ‘gpt1’, each carrying one G-PCC component (geometry or attribute).

As illustrated, G-PCC bit-stream 200 comprises a sequence of point cloud frames, in particular frame N, referenced 205, a coded point cloud frame comprising here a sequence of zero or more slices sharing the same value of FrameCtr (a kind of timestamp). For example, point cloud frame N comprises two slices referenced 210-1 and 210-2. Each slice comprises one geometry data unit that codes the geometry (that may be followed by any optional duplicate geometry data units) and may comprise one or more attribute data units or one or more defaulted attribute data units (DUs) that code the slice attributes. The number of data units may vary from one frame to another (for example a different number of slices, new parameter sets, FSAP data units, etc.). For the sake of illustration, slice 210-1 comprises one geometry data unit 215-1 and two attribute data units 220-11 and 220-12. Likewise, slice 210-2 comprises one geometry data unit 215-2 and two attribute data units 220-21 and 220-22.

A slice is identified by the GDU's slice_id. Slices may be repeated within a coded point cloud frame, but their repetition should not change the value of slice_id. Slice partitioning may be used to allow parallelization, to improve coding efficiency, and/or to enable other functionalities such as error resiliency and progressive decoding.

During encapsulation of G-PCC bit-stream 200 in media file 230, all the items of geometry information of the G-PCC bit-stream may be stored and described in a geometry track and each attribute of the G-PCC bit-stream may be stored and described in a corresponding attribute track. For example, the geometry data units may be stored and described in geometry track 235-1, the attribute data units of the first attribute may be stored and described in attribute track 235-2, and the attribute data units of the second attribute may be stored and described in attribute track 235-3. It is observed that the tracks belonging to the same G-PCC sequence, or bit-stream, are preferably time-aligned (i.e. each track comprises samples, each of the sample comprising a sample time (e.g. in ‘stts’ or ‘ctts’ box) to store a time value, so that there exists one sample of each track associated with a given time value. For example, samples 245-1, 245-2, and 245-3 are time-aligned samples. Accordingly, each point cloud frame, for example point cloud frame 205, may be described as a set of samples in ISOBMFF, like sample set 240, comprising one sample in each track, each sample within the same track representing the same kind of information or the same component (geometry information or specific attribute information). For example, sample 245-1 of track 235-1 comprises geometry information, sample 245-2 of track 235-2 comprises attribute information of the first attribute, and sample 245-3 of track 235-3 comprises attribute information of the second attribute.

Following specification ISO/IEC 23090-18 on multitrack encapsulation, the media file ends up with samples in different tracks. Each sample in a given track contains data units of a given type from different slices in the original bit-stream 200. For example, slices 210-1 and 210-2 have their geometry data units and geometry related information (e.g. GPS or tile inventory) in track 235-1 (i.e. GDUs 215-1 and 215-2) while the same slices have their attribute data units and attribute related information (e.g. APS or frame-specific attribute data unit) in the attribute tracks 235-2 (i.e. ADUs 220-11 and 220-21) and 235-3 (i.e. ADUs 220-12 and 220-22). It is to be noted that representation of media file 230 is a simplified view of an ISOBMFF. It should be understood that track and sample description are available under a ‘moov’ box and a ‘trak’ box indexing data (the GDU or ADU). Likewise, it should be understood that the data are in a media data box (e.g. ‘mdat’, ‘imda’, or ‘idat’ box). When the media file is a fragmented ISO Base Media file, a track fragment and the description of samples for this fragment are in ‘moof’ and ‘traf’ boxes with their associated ‘mdat’ or ‘imda’ boxes storing the samples' data. It is also to be noted that each sample comprises data units from different slices. The inventors have observed that there exists a boundary in each sample, that may be implicit or that may be signalled, enabling to distinguish data units from one slice to data units from another slice, as illustrated with dotted line 250.

It is observed here that a bit-stream reconstructed by a parser should fulfil some rules to make sure that a decoder is able to decode and/or render the point cloud data. Examples of such rules related to TLV units order, to TLV constraints, and/or to TLV slice constraints are the following;
each slice should contain a single GDU followed by any optional duplicate GDUs and then any ADUs or defaulted attribute DUs,
DUs belonging to different slices should not be interleaved, and
every slice should have a corresponding ADU or defaulted attribute data unit for every attribute enumerated in the SPS.

In order to generate a valid G-PCC bit-stream from media file 230 and from specification ISO/IEC 23090-18, for example G-PCC bit-stream 255, some mechanisms should be used to concatenate in a correct order the data units stored in the different tracks of the media file, to comply with the rule from ISO/IEC 23090-9 according to which data units belonging to different slices should not be interleaved. To make sure that any parser, independently of its implementation, generates a compliant bit-stream for G-PCC decoders, at least from slice ordering point of view, one of the following mechanisms may be used:
reconstruction mechanism implementing reconstruction rules considering slices (parser side),
encapsulation mechanism implementing constraints on the multi-track encapsulation (writer side, used by parser side),
signalling mechanism providing indications to be used during the reconstruction process (implemented on the writer side and used on the parser side), these indications being
   static,
   dynamic,
   hybrid (static and redefined for some specific/exception samples or for some fragments)
   mutualized within a geometry track,
   spread within each component track (tiled or not).

The mechanism to be used may depend on the configuration of the considered G-PCC bit-stream to be encapsulated and parsed, for example may depend on whether all the slices of the point cloud frames have the same structure or not. For example, when the slice structure is stable (e.g. it comprises the same number of slices across samples and the same number of TLVs per slice), there may be no need to provide indication on sample or group of sample basis, but rather for all the samples of a track or track fragment, i.e. by using of a static approach. The mechanism to be used may also depend on the ISO/IEC 23090-18 level of specification: does it constrain writers to respect slice ordering in each component track or not. Depending on the level of specification, a parser may have some a priori or not. When no a priori can be assumed, the parser may then use an additional indication from the media file.

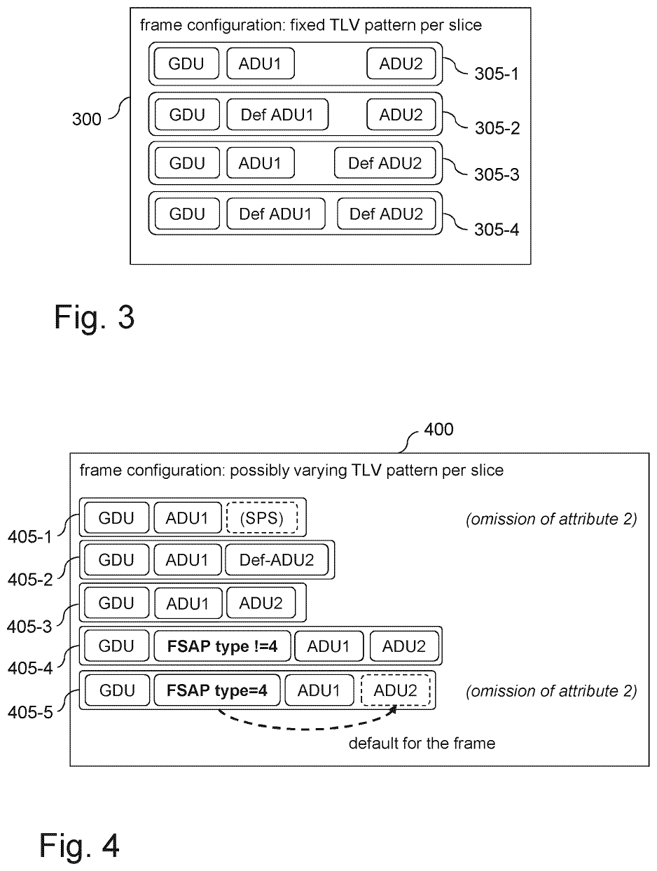

FIG. 3 illustrates a first example of the structure of a frame of a sequence of frames of a G-PCC bit-stream to be encapsulated and parsed, wherein all the slices of the point cloud frames have the same structure.

It is assumed here that the SPS for the point cloud sequence declares two attributes (like in FIG. 2). According to the example of FIG. 3, a single structure of data units within a slice is used for all the slices of the frames of the considered G-PCC bit-stream. In other words, there is a fixed TLV pattern per slice.

As illustrated in FIG. 3, each slice 305-1, 305-2, 305-3, and 305-4 of frame 300 comprises one geometry data unit (GDU) followed by two attribute data units (ADUs) or defaulted attribute data units, also denoted Def ADUs (for the sake of clarity, only one slice is represented for frame 300, but there may be multiple slices, assuming here that they have the same TLV pattern: one GDU followed by two ADU or defaulted ADU).

While the structure illustrated in FIG. 3 may advantageously be used for encapsulating and/or parsing G-PCC bit-stream, the inventors have observed that it may be convenient to consider that such a structure may change from one slice to another to cope with data losses (at the writer or parser side) or when partial reconstruction is done at the receiver side. For example, although a G-PCC bit-stream to be encapsulated and parsed comprises slices that have the same structure, it may be considered that the G-PCC bit-stream to be encapsulated and parsed does not comprise slices that have the same structure so that parsing may be done appropriately even when data units are lost. This may be the case for example when transmission is not reliable, for example when using RTP-based delivery for live or real-time transmission.

FIG. 4 illustrates a second example of the structure of a frame of a sequence of frames of a G-PCC bit-stream to be encapsulated and parsed, wherein all the slices of the point cloud frames do not have the same structure. Again, it is assumed here that the SPS for the point cloud sequence declares two attributes (and again, for simplicity only one slice for the frame 400 is represented, but there may be multiple slices for the frames of the point cloud sequence). However, according to this example, a slice may contain a number of attribute or defaulted attribute data units different than the expected number of attribute or defaulted attribute data units. For the sake of illustration, slice 405-1 of frame 400 comprises one geometry data unit and one attribute data unit while slice 405-3 comprises one geometry data unit and two attribute data units. Indeed, it has been suggested in ISO/IEC JTC1/SC29/WG11 MPEG m53681 to signal a defaulted attribute data unit to avoid the need to encode (or decode) attribute data where all attribute values are identical, by adding a defaulted attribute value to the SPS attribute description in order to handle omissions of coded attribute data. Slice 405-1 makes use of the default SPS attribute value for the second attribute while slice 405-5 uses another concept that is the Frame-specific attribute properties data unit (FSAP). When the FSAP data unit contains an attribute property with type equal to 4, it means that the FSAP data unit defines default values for a given attribute that will apply to a specific frame. Accordingly, the attribute data unit for the second attribute of slice 405-5 may be omitted. For other frames, the default values or actual encoded values may apply.

It is to be noted that there exist cases where losses occur either before encapsulation or during transmission. When a bit-stream gets corrupted, an advanced writer may analyse the bit-stream and detect missing data units. When the writer can detect missing attribute data units, it may take the initiative of padding the bit-stream with defaulted attribute data units. Likewise, at the receiver or client side, when a parser detects that some attribute data units are missing, it may take the initiative of padding defaulted attribute data units to generate a compliant bit-stream with the number of attributes declared in the SPS. This last point also applies for partial extraction: when a bit-stream is encapsulated in multiple tracks, for example one geometry track and N attribute tracks, when the parser extracts only a subset of attribute tracks with the geometry track, for example M tracks with M<N, it may pad with N-M defaulted attribute data units to avoid rewriting of the SPS and the declaration of number of attributes (declaring N attributes). It may pad the attributes in any order provided that it does not interleave data units from different slices.

### Encapsulation Process

FIG. 5 illustrates an example of steps of an encapsulation process according to some embodiments of the invention, making it possible to encapsulate point cloud data in multiple tracks in an interoperable way for a parser to generate compliant G-PCC bit-streams. For the sake of illustration, the steps illustrated in FIG. 5 may be carried out by encapsulation module 102 in FIG. 1.

According to the illustrated example, a first step (step 500) is directed to initializing the reception of the point cloud data (or volumetric data) to encapsulate. Next, the encapsulation module is configured (step 505) as a function of the type of data to be processed (e.g., depending on whether the point cloud data are compressed or not, depending on whether the point cloud data should be analyzed or not, depending whether the compressed point cloud contains tiles or slices or not). This can be done by a user or by an application. For the sake of illustration, the configuration may comprise choosing a single track or multi-track encapsulation, choosing a live or offline encapsulation, choosing a description mode, for example describing tiles or not. In the scope of this disclosure, multi-track encapsulation is set with or without tile tracks.

Configuration step 505 may also be used to indicate whether the same configuration parameters should apply for encapsulating the whole point cloud data (static configuration) or may change when encapsulating the point cloud data (dynamic configuration). In case the media file writer also contains a compression module, for example compression module 106 in FIG. 1, the configuration step may comprise setting parameters for the encoder: for example, setting the slice or tiles structure. The compression module may encode these configuration parameters, for example as additional syntax elements of a G-PCC bit-stream, for example in the Sequence Parameter Set (SPS), or in a dedicated TLV type, for example the tile inventory data unit for the description of the bounding boxes for tiles. For example, the SPS may provide information on slice dependencies regarding bit-stream parsing and decoding (like the entropy_continuation parameter). When the point cloud data are received by the encapsulation module as a G-PCC bit-stream (e.g. a bit-stream generated by the compression module 106 in FIG. 1, or by an external compression module), the configuration of the encapsulation module may use information from the parameter sets of the bit-stream or supplemental information associated with the bit-stream (sometimes called SEI (Supplemental Enhancement Information messages) or information provided in user data units. Supplemental information means encoded parameters that are not mandatory to decode the point cloud data but that may help an application using these point cloud data by providing additional information.

Further to the configuration of the encapsulation module, metadata structures of a media file such as top-level boxes (e.g., ‘ftyp’ or ‘styp’, ‘moov’ and its ‘trak’ sub-boxes, ‘mdat’ box, and boxes for sample description like ‘stbl’ or ‘stsd’) are created during an initialization step (step 510). Such an initialization step may comprise reading parameter sets (e.g. a sequence parameter set, a geometry parameter set, and/or an attribute parameter set) from an encoded bit-stream of point cloud data or may comprise obtaining information about a sensor used to obtain the point cloud data like a number of points, the types of attributes associated with the points (e.g., color, reflectance, timestamp, areas of interests, etc.) or may comprise obtaining information about the encoder settings. It is noted that some of the setting parameters defined in configuration step 505 may be reflected in track description or sample description. Likewise, user data or supplemental information, when available, may be entirely or partially included in the media file. Parts of the configuration information (configuration parameters, parameter sets, user data, or supplemental information) may be gathered in a metadata structure, for example a structure dedicated to sample description, like a sample entry (e.g. ‘gpc1’, ‘gpcg’, ‘gpeb’, or any 4CC for a G-PCC component track) or a configuration box (e.g. ‘gpcC’). The configuration information may contain information on slice configuration in the bit-stream: presence or absence of slices, optionally a number of slices per frame, whether this number is constant or not, whether slices are repeated, presence of slice set or not, is there a slice reordering constraint or not. Having this information may put less constraint on parser (e.g. no need to check slice orders in reconstructed bit-stream if slice_reordering_constraint=0). Some of this information may be obtained from parameter sets (e.g. slice reordering constraints), some may require bit-stream analysis (like the number of slices and the number of slices per frame). Likewise, entropy_continuation_enabled, from the SPS, may be useful to reflect in sample description since this may also constrain reconstruction process from inter slice order point of view. This may be determined by encapsulation module during initialization step 510 or may be computed all along the encapsulation and written in the file at the end of the encapsulation (this latter mode being less relevant for live packaging during live or low-latency streaming).

An example of a metadata structure to provide slice configuration information may be defined as a new box, for example inheriting from FullBox, for example as a SliceConfigurationInformationBox, identified by the ‘scfg’ four-character code, as follows:

```
aligned(8) class SliceConfigurationInformationBox
  extends FullBox(‘scfg’, version = 0, 0) {
  unsigned int(1) slice_present;
  if (slice present) {
    unsigned int(1) slice_reordering_constraint;
    unsigned int(1) entropy_continuation_enabled
    unsigned int(1) repeated_slices;
    unsigned int(1) same_num_slices_per_frame;
    bit(3) reserved = 0;
    if (same_num_slices_per_frame) {
      unsigned int(16) num_slices_per_frame;
    } else {
      unsigned int(16) max_num_slices_per_frame;
    }
  } else {
    bit(7) reserved = 0;
  }
}
```

wherein
slice_present indicates whether the data for the samples contain slices or not. When set to 1, this parameter indicates that samples may contain slices. When set to 0, this parameter indicates that the samples do not contain any slices,
slice_reordering_constraint has the same semantics as in ISO/IEC 23090-9,
entropy_continuation_enabled has the same semantics as in ISO/IEC 23090-9,
repeated_slices indicates whether slices may be repeated within some samples. When set to 1, this parameter indicates that samples may contain repeated slices. When set to 0, this parameter indicates that the samples do not contain repeated slices,
same_num_slices_per_frame indicates whether all the samples have the same number of slices or not. When set to 1, this parameter indicates that the samples have the same number of slices. When set to 0, this parameter indicates that at least two samples do not have the same number of slices,
num_slices_per_frame indicates the number of slices per sample (when constant, not present otherwise), and
max_num_slices_per_frame indicates the maximum number of slices for a sample of the track.

This box may be stored in any G-PCC track as an optional box of the sample entry. As an alternative the parameters present in the slice configuration information may be stored in the GPCCDecoderConfigurationRecord within the ‘gpcC’ box.

Following initialization step 510, the writer may optionally determine (step 515) whether indication for reconstruction rule may be needed or not and if needed, whether it should be static (or implicit, i.e. applying to all samples) or dynamic (or explicit, i.e. possibly one rule per sample, per group of samples, or per fragment or segment). By default, or at least for live packaging, the writer may consider explicit reconstruction rule because it allows handling the majority of the configurations, for example the configurations described by reference to FIGS. 3 and 4.

The following steps describe the encapsulation with explicit reconstruction rules or indications helping reconstructing valid bit-streams from multiple tracks.

Next, the encapsulation process enters in a processing loop for processing each frame of the point cloud data.

After reading a point cloud frame (step 520), for example data unit by data unit from a bit-stream of compressed point cloud data, the encapsulation module determines whether the read data correspond to geometry data (test 525). If it is determined that the read data are geometry data, the read data unit is stored in the geometry track (step 530). In case of explicit reconstruction rule, the slice_id and optionally the slice tag of the GDU header is decoded and memorized. The size of the read data unit may also be memorized along with the slice_id and optionally prev_slice_id (an identifier of the slice onto which the current slice may depend). When the SPS indicates that entropy_continuation is active, the writer may also decode the value of the slice_entropy_continuation parameter and, when set to 1, decode the value of the prev_slice_id parameter and memorize this latter value (this is to guarantee correct inter-slice order).

When the read geometry data unit is detected as a duplicated GDU (for example by computing a difference onto the data units, or by checking if they have the same slice_id), depending on the encapsulation mode, the writer may store this duplicated GDU during step 530 or discard it and store only one instance of duplicated GDUs. This encapsulation choice (presence or absence of duplicated GDUs) may be indicated as a track property or in the sample description (e.g. in sample entry or in configuration box, for example in the GPCCConfigurationBox or GPCCComponentInfoBox) of the geometry track.

Determining the type of the read data unit may comprise determining the type of a G-PCC unit (or TLV unit) by reading its type using a G-PCC unit parser (not represented).

Back to test 525, if it is determined that the read data are not geometry data, another test is carried out to determine whether the read data correspond to attribute data (test 535). If the read data correspond to attribute data, the type of attribute data may be obtained by the G-PCC unit parser (step 540) to determine the track where the read data unit is to be stored (step 545). The writer preferably memorizes the size of the read attribute data unit and may decode its adu_slice_id (i.e., the identifier of the slice to which depends the ADU). It is recalled that for a G-PCC bit-stream, an attribute data unit corresponds to a TLV unit of ADU type, an APS (Attribute Parameter Set), a defaulted attribute data unit, or a FSAP data unit (frame-specific attribute property). If the read data do not correspond to attribute data (step 535), for example if the read data correspond to a SPS, to a Frame boundary marker, or to user data, the read data unit is stored in the geometry track (step 530).

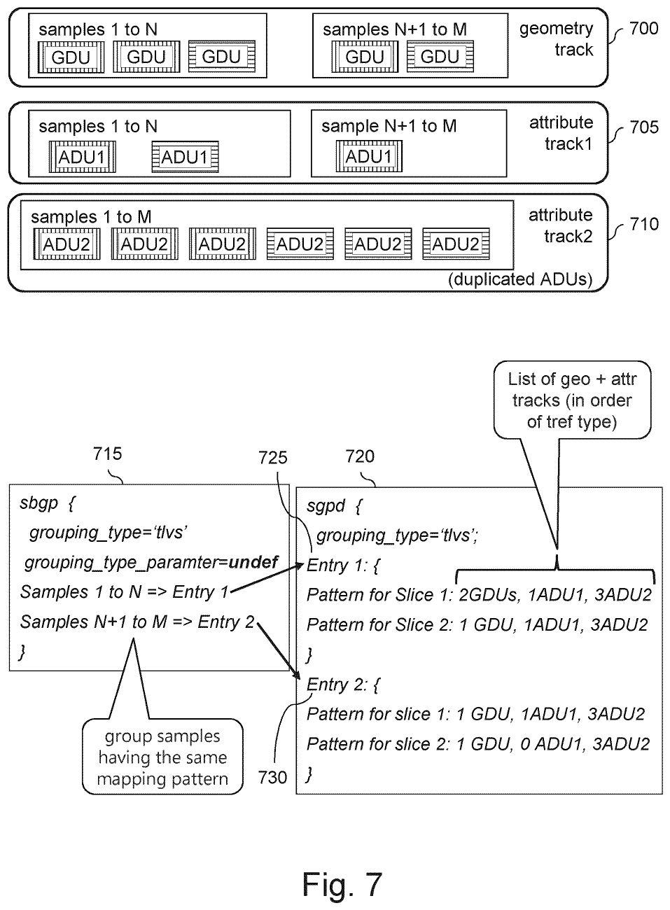

When a data unit is stored in a track (step 550), the writer stores information on this data unit and related slice information. The metadata structure where this item of information is stored and the type of information is described hereafter in reference to FIGS. 7, 8, and 9. As illustrated, the process iterates over data units within a frame (test 555) and within the frames (test 560) of the point cloud sequence to encapsulate.

### Handling Duplicated Data Units

It is to be noted that the indication of preserving or discarding duplicated data units (geometry or attribute data units or both) may also apply to single track or tile tracks without component tracks (still with indication at track level or in sample description like sample entry or configuration box, for example in the GPCCConfigurationBox or GPCCComponentInfoBox when present). It may be indicated by a parameter, for example on 2 bits where a first bit, when set to 1, indicates the presence of duplicated GDUs and a second bit, when set to 1, indicates presence of duplicated ADUs. When stored in GPCCComponentInfoBox, this may be indicated with some reserved flags values of the box. This informs parsers that for bit-stream reconstruction, a choice is also possible regarding these duplicated data units: they may be kept or discarded by the parsers in the reconstructed bit-stream. Duplicated data units may occur when repeated slices are present. The same indication as above may also apply to repeated slices: a third bit, when set to 1, may indicate that repeated slices have been removed from the media file (writer) or from the reconstructed bit-stream (parser). Again, a parser may decide to keep or to discard the repeated slices. The values of these parameters may be set during the configuration step of the encapsulation module (step 505), or may be determined by the encapsulation module itself during this configuration. For example, when the writer (or server) knows that the transmission is reliable (for example over HTTP), the duplicated data units are not kept and the indication that duplicated data units are discarded is set in at least one of the encapsulated tracks. Alternatively, when the writer (or server) knows that the transmission may not be reliable (for example using RTP), it may preserve the duplicated data units or preserve the repeated slices. When the indication that duplicated units are preserved is set, the writer may duplicate APS in attribute tracks (instead of encapsulating it in just one of the attribute track). This provides some robustness in case of loss and also provides robustness for reconstruction from a subset of tracks compared to complete set of tracks.

### Parsing Process

FIG. 6 illustrates an example of steps of a parsing process according to some embodiments of the invention. For the sake of illustration, these steps may be carried out by the de-encapsulation module 132 in FIG. 1, that may be also called parser or reader. The parsing process on FIG. 6 allows a parser to reconstruct a compliant G-PCC bit-stream from multi-track encapsulation (tiled or not) by respecting TLV orders and rules for slices defined in ISO/IEC 23090-9.

As illustrated, a first step is directed to receiving the media file to parse (step 600). It may be streamed using a streaming module, for example streaming module 134 in FIG. 1, or it may be read from a storage location. The streaming may use a reliable or a non-reliable (possibly with transmission losses) protocol, depending on the application. Next, the parser is initialized (step 605). The initialization may be carried out by parsing the boxes of the media file, for example the top-level ‘moov’ box, the ‘trak’ boxes, and sample description boxes. When the media player contains a decoder (or a decompression module, e.g. decompression module 136 in FIG. 1), the decoder may also be initialized during this step, for example using decoder configuration information from the sample description (e.g. G-PCC configuration box ‘gpcC’). During this step, the parser may obtain information on slice configuration indicated in the media file by the writer (for example at step 510 in FIG. 5). The initialization of the parser may contain the reading of indication written by the encapsulation module (for example according to one of the embodiments in relation to FIGS. 7, 8, and 9). As described with reference to the writer, the indication may be implicit (or static) or may be dynamic (or explicit). The steps illustrated in FIG. 6 focus on the case where the indication is explicit and dynamic. This means that the parser may need to check the indication on each sample, group of samples, movie fragment, or media segment. In case the indication is static, it can be read once for all during step 610.

Next, the reading of a slice starts (step 610). This step comprises updating a slice counter or slice index, for example starting from value 1, or starting from the value of the gdu_slice_id decoded from the first GDU (that may be read at step 615) of the current sample. To locate data units to read for the current sample, the parser (or the de-encapsulation module) reads sample description from the metadata part of the received media file to locate corresponding media data in the media data box of the received media file. It also identifies the geometry track and the attribute tracks by inspecting the TrackReferenceBox. Reading a sample then consists in reading data units from time-aligned samples in the geometry track and in the associated attribute tracks. Reading is done on a slice basis to make sure that data units from different slices are not interleaved. This is where indication for reconstruction rules may apply.

In step 615, the parser reads data units for the current slice in the geometry track. To that end, it may read GDU data units until their payload changes (to collect duplicated GDUs) or read a number of GDU data units based on an indication in the media file when present. The parser then records its reading position in the ‘mdat’ box for next slice. Optionally, the parser may decode the gdu_slice_id or obtain it from an indication in the media file when present and check that it matches the current slice_id initialized at step 610. The parser may also compare the header of a current GDU with the one of a next GDU to determine whether there is a change in the header, meaning that at least the slice identifier has changed or may obtain the slice change from an indication in the media file when present.

Next, in step 620, the parser reads data units from the first referenced track (i.e. the first attribute track referenced by the geometry track). As for GDUs, the parser may collect duplicated ADUs when present, by checking that data unit payload does not change or by decoding the adu_slice_id (or defattr_slice_id for Defaulted ADU) and checking that it matches the current slice index or may obtain it from an indication in the media file when present. The parser may also compare the header of a current ADU with the one of a next ADU to determine whether there is a change in the header, meaning that at least the slice identifier has changed or may obtain the slice change from an indication in the media file when present.

Next, in step 625, the parser checks whether other attribute tracks are referenced by the geometry track. If there is at least one other attribute track referenced by the geometry track, the parser iterates over steps 620 and 625 so as to process all the referenced attribute tracks. When the last attribute track is reached in step 625, the read data units (corresponding to a single slice) are appended to the bit-stream under reconstruction (step 630). The bit-stream may then be processed by the decoder (on the fly) for rendering or may be stored for later, on-demand decoding or rendering.

When there is a mismatch between a decoded slice_id and a current one, this may be interpreted as an error. However, the parser may store the read data units to later reorder the data units in appropriate slice order and then flush these read data to the bit-stream being reconstructed.

Once the data units of a slice have been parsed, the reader checks whether it reached the end of the sample (step 635). This may be determined from the payload bytes indicated in each G-PCC unit. If the end of the sample is not reached, the slice counter is incremented (step 640), and the algorithm loops on step 615 to parse the data units of the next slice. On the contrary, if the end of the sample is reached, a test is carried out to determine whether there is at least one remaining sample to process (step 645). If there is at least one remaining sample to process, the algorithm loops on step 610 to start reading a first slice of a new sample. The algorithm ends when the last sample of the point cloud sequence is reached.

When collecting attribute data units in step 620, a parser may check whether, at the end of the loop on attribute tracks, it collected the expected number of attributes, i.e. the same number of attribute data units as indicated in the SPS. If it is not the case, the parser may take the initiative of padding the current slice, for example before step 630, with a number of defaulted attribute data units so that the expected number of attributes is reached. To identify missing attribute data units, the parser checks the attrIdx from collected attribute data units and compares it with the list declared in the SPS. Missing ones are created as defaulted data units and take as value either the default value for any attribute (for example to Exp2(attr_bitdepth_minus1[attrIdx]) as defined in ISO/IEC 23090-9) or the default value indicated in the SPS when it exists. This specific step may depend on a setting of the parser like an integrity check mode that is activated or not (by a user, by an application, by scripting, or by default). This integrity check mode may also lead the parser to store a corrupted media file for point cloud data into a Partial File Format, possibly with indication of complete segments, corrupted segments, and missing segments.

Another setting may consist in setting the parser in a “purge” mode. When this mode is set, for media files wherein duplicated data units are present (either in a dedicated metadata structure or determined by the parser), the parser removes these duplicated data units and do not pass them to the point cloud decoder. In this mode, the parser may do the same for repeated slices. The two modes for duplicating data units or repeated slices may correspond to distinct configurations for the parsers or may be combined into a single “purge” mode.

In the following, several embodiments for interoperability between ISO/IEC 23090-18 writers and readers are described to
encapsulate point cloud data in a constrained and standardized way so that parsers unambiguously reconstruct a valid bit-stream from multiple tracks or
encapsulate point cloud data with indication in the media file on how to reconstruct from multiple tracks without interleaving data units from different slices.
   Constraints to be Applied for Multi-Track Encapsulation of Slice-Based Point Cloud Frames (Enabling Parsing without Using Additional Signalling)

According to this embodiment, encapsulating a G-PCC bit-stream comprising slice-based point cloud frames in a multitrack media file does not require adding specific signalling in the media file, but involves encapsulation constraints so that a parser may parse the data units properly. Such constraints apply on the component tracks (or attribute tracks), tiled or not. The description of the multi-track encapsulation is further specified with the following statement(s):
the slice order in each attribute track matches the slice order in the geometry track; and
the slice number in each attribute track matches the slice number in the geometry track.

Optionally, when entropy continuation is in use or when slice_reordering constraint is indicated in the G-PCC bit-stream, inter-slice order among the geometry and the attribute tracks it references complies with entropy_continuation indication.

Parsers can then rely on these constraints (at least the first one) to collect the appropriate number of TLVs per slice in each component track and optionally to determine a number of slices. To determine the number of TLVs per slice, either from the geometry track or from on attribute track, the parser while reading data units may maintain a slice_id current value and verify that the read data units match this current slice_id (as described with reference to FIG. 6). Alternatively, the parser may collect ADUs or GDUs within a track until the payload changes. Even only the first bytes may be used to detect a possible change in the slice_id.

The reconstruction of a point cloud frame from a geometry track (‘gpc1’ or ‘gpcg’) referencing attribute tracks (‘gpc1’ or ‘gpcg’) may be performed from time-aligned samples on a slice basis, by concatenation of G-PCC units in the following order:
any G-PCC unit declared in the sample entry,
any G-PCC unit with the type set to SPS (value 0) or to GPS (value 1) from the geometry track (from sample entry or within samples),
when present, any G-PCC unit with the type set to Tile Inventory data unit (value 5) or to User Data data unit (value 9) from the geometry track,
   for each slice,
any G-PCC unit with the type set to GDU (value 2) from the geometry track, all the GDUs having the same slice_id,
   and for each attribute track referenced from the geometry track via the ‘gpca’ track reference type:
any G-PCC unit with the type set to APS (value 3) from the attribute track,
any Frame-Specific Attribute Property data unit (value 8) from the attribute track,
any G-PCC unit with the type set to Attribute data unit (value 4) or to Defaulted Attribute data unit (value 7) from the attribute track having the same value of adu_slice_id or defattr_slice_id,
any G-PCC unit with the type set to User Data data unit (value 9) from the attribute track, and
after collected ADUs for all the slices, any G-PCC unit with the type set to Frame Boundary Marker data unit (value 6) from the geometry track, when present.

The above encapsulation constraints may also apply to G-PCC tile tracks (‘gpt1’) referenced from a ‘gpcb’ tile base track. In this case, for a set of geometry and associated attribute tracks corresponding to the same set of one or more tiles, the slice order in each attribute track matches the slice order in the geometry track and the slice number in each attribute track matches the slice number in the geometry track. Optionally, the inter-slice order may also apply when slice_reordering_constraint is set or when entropy_continuation is set. The reconstructions are the same as above, but applied onto each set of geometry and associated attribute tracks of the different tiles or set of tiles referenced by the ‘gpcb’ tile base track.

Parsing Multi-Track Media File Encapsulating Slice-Based Point Cloud Frames without Specific Signalling

According to this embodiment and like the previous one, encapsulating a G-PCC bit-stream comprising slice-based point cloud frames in a multitrack media file does not require adding specific signalling in the media file. In addition, it does not expect a specific behaviour of the writer. According to this embodiment, a parser checks the slice identifier of the data units each time a data unit is read to make sure that the data units are concatenated in a proper order in the reconstructed bit-stream.

The reconstruction of a point cloud frame from a geometry track (e.g. ‘gpc1’ or ‘gpcg’) referencing attribute tracks (e.g. ‘gpc1’ or ‘gpcg’) may be performed from time-aligned samples on a slice basis, while considering curSliceID being the slice identifier of the current slice (i.e. the slice being processed), the curSliceID being incremented after all the data units corresponding to this slice identifier have been processed. Reconstruction is performed by concatenation of G-PCC units in the following order, after data units from the sample entry are appended to the bit-stream, for the first sample:
any G-PCC units with the type set to SPS (value 0) or to GPS (value 1) from the geometry track (from sample entry or within sample),
when present, any G-PCC unit with the type set to Tile Inventory data unit (value 5) or to User Data data unit (value 9) from the geometry track,
   for each slice,
any G-PCC unit with the type set to GDU (value 2), from the geometry track, having a slice_id equal to curSliceID,
   and for each attribute track referenced from the geometry track via the ‘gpca’ track reference type:
any G-PCC unit with the type set to APS (value 3) from the attribute track,
any Frame-Specific Attribute Property data unit (value 8) from the attribute track,
any G-PCC unit with the type set to Attribute data unit (value 4) or to Defaulted Attribute data unit (value 7) from the attribute track, having an adu_slice_id or a defattr_slice_id equal to curSliceID,
any G-PCC unit with the type set to User Data data unit (value 9) from the attribute track, and
after the ADUs collected for all the slices, any G-PCC unit with the type set to Frame Boundary Marker data unit (value 6) from the geometry track, when present.

For G-PCC tile tracks carrying one G-PCC component, referenced from a ‘gpcb’ tile base track, the reconstruction would be the same as above, but applied onto each set of geometry and associated attribute tracks of the different tiles or set of tiles referenced by the ‘gpcb’ tile base track.

Encapsulating Slice-Based Point Cloud Frames into a Multi-Track Media File Using Signalling Information to Improve Parsing

FIG. 7 illustrates an example of adding static or semi-static indication in a multi-track media file encapsulating slice-based point cloud frames to help a parser to reconstruct a bit-stream complying with a predetermined format, for example to reconstruct a G-PCC bit-stream.

While FIG. 7 illustrates a particular embodiment wherein the additional indication is located in the geometry track, it is noted that this additional indication may be split into the different geometry and attribute tracks.

The additional indication is based on sample grouping.

According to the illustrated example, the G-PCC bit-stream is encapsulated in a geometry track, referenced 700, and two attribute tracks, referenced 705 and 710. As illustrated, samples 1 to N of geometry track 700 comprise two GDUs for a first slice (represented with horizontal hatching) and one GDU for a second slice (represented with vertical hatching). Samples N+1 to M of the same geometry track have a different pattern: one GDU in the first slice (still represented with horizontal hatching) and one GDU in the second slice (still represented with vertical hatching). Still for the sake of illustration, attribute track 705 comprises different data units or TLV unit patterns per slice for samples 1 to N and for samples N+1 to M. According to the illustrated example, attribute track 710 contains duplicated ADUs.

While encapsulating these data units, the writer may generate metadata structures like metadata structures 715 and 720. These structures may be sample to group and sample group description boxes from ISOBMFF that may be included in the sample description at the beginning of the file or in movie fragments, overtime. Metadata structure 715 contains a grouping_type, for example equal to ‘tlvs’ for “TLV per Slice” to map group of samples to sample group entries in metadata structure 720. The sample group entries may inherit from the VolumetricVisualSampleGroupEntry defined in ISOBMFF. The sample group provides a mapping of TLVs to slices, that may help readers to extract the exact number of TLV units from each of the geometry and associated attribute tracks.

For example, samples 1 to N are mapped into a first entry while samples N+1 to M are mapped into a second entry in metadata structure 720. It is to be noted that default sample grouping may be used when all samples share the same pattern (in such a case, metadata structure 715 may be omitted and only metadata structure 720 is present). Moreover, when the configuration does not change over time, the sample grouping may be declared as static using appropriate flags values for metadata structure 720 defined in ISOBMFF. The content of metadata structure (or box) 720 contains a list of entries indicated by an entry_count parameter. The grouping type parameter for this box is also ‘tlvs’ (for example, or any dedicated 4CC) to pair this box with a corresponding box in metadata structure 715, when present. Each entry in box 720 contains a list of patterns (for example one per slice) and indicates the number of GDUs and ADUs to collect in the different tracks. The declaration within each sample group entry follows the same declaration order as the ‘gpca’ track reference linking the geometry track to the attribute tracks. It is to be noted here that depending on configuration or settings or application needs, the writer may have declared only one instance of a given ADU (when filtering mode is activated, duplicated data units are not preserved). In such a case, the last value in patterns for the first slice in both entries (referenced 725 and 730) would be 1 and last entry in patterns for the second slice in both entries 725 and 730 would also be 1.

Metadata structures 725 or 730 may be defined as follows:

### Definition

Group Types: ‘tlvs’
Container: Sample Group Description Box (‘sgpd’)
Mandatory: No
Quantity: Zero or more
   The use of ‘tlvs’ for the grouping_type in sample grouping represents the assignment of samples in G-PCC track to the TLV to slice mapping information carried in this sample group. When a SampleGroupDescriptionBox with grouping type equal to ‘tlvs’ is present, an accompanying SampleToGroupBox with the same grouping type may be present (when default sample grouping cannot apply). The grouping_type_parameter in this SampleToGroupBox is undefined.
   The ‘tlvs’ sample group may be present in ‘gpc1’ or ‘gpcg’ geometry track or in ‘gpt1’ geometry tile-track referenced by a ‘gpcb’ tile base track.

```
Syntax
aligned(8) class GPCC_TLVToSliceGroupEntry( ) extends
VolumetricVisualSampleGroupEntry (‘tlvs’) {
  unsigned int (16) num_slices;
  for (int i = 0; i < num_slices; i++){
    unsigned int (8) num_tlvs[1 + nb_referenced_tracks]
  }
}
```

### Semantics

num slices indicates the number of slices present in the samples associated with this sample group and
num_tlvs provides a list of numbers of consecutive TLV units per track associated with a given slice in the samples associated with this sample group. The length of the list is equal to the number of track references from the geometry track containing this sample group to attribute tracks, plus one. The list is ordered starting by the number of TLV units for the geometry track, followed by the number of TLV units for each attribute track referenced by the ‘gpca’ track reference, in the order of these track references.

The following reconstruction rule, based on metadata structure 720 or 720 plus 715, is proposed for inclusion in section 7.4 of ISO/IEC 23090-18.

The reconstruction of a point cloud frame from a geometry track (‘gpc1’ or ‘gpcg’) referencing attribute tracks (‘gpc1’ or ‘gpcg’) is performed from time-aligned samples on a slice basis, by concatenation of G-PCC units in the order indicated by the ‘tlvs’ sample group of the geometry track.

A point cloud frame is reconstructed from multiple component tracks by:
identifying its corresponding sample in the sample group description;
identifying the mapping of a TLV into a slice for this sample from the ‘tlvs’ sample group description box of the geometry track, and
for each slice in this sample, reading the number of TLV units from the geometry track corresponding to the number of TLV units indicated in the first value of the ‘tlvs’ entry
for each attribute track referenced from the geometry track via the ‘gpca’ track reference type, reading a number of TLV units from the current attribute track corresponding to the next value in the ‘tlvs’ entry.

The following reconstruction rule is proposed for inclusion in section 7.5 of ISO/IEC 23090-18.

For ‘gpt1’ geometry tracks referenced by a ‘gpcb’ tile base track, the same reconstruction as proposed for inclusion in section 7.4 of ISO/IEC 23090-18 applies on each set of geometry tile track and its associated attribute tile tracks containing more than one slice (when a tile track only contains one slice, a sample-based reconstruction may be used, i.e. concatenation of the timed-aligned samples from geometry track and its associated attribute track(s)).

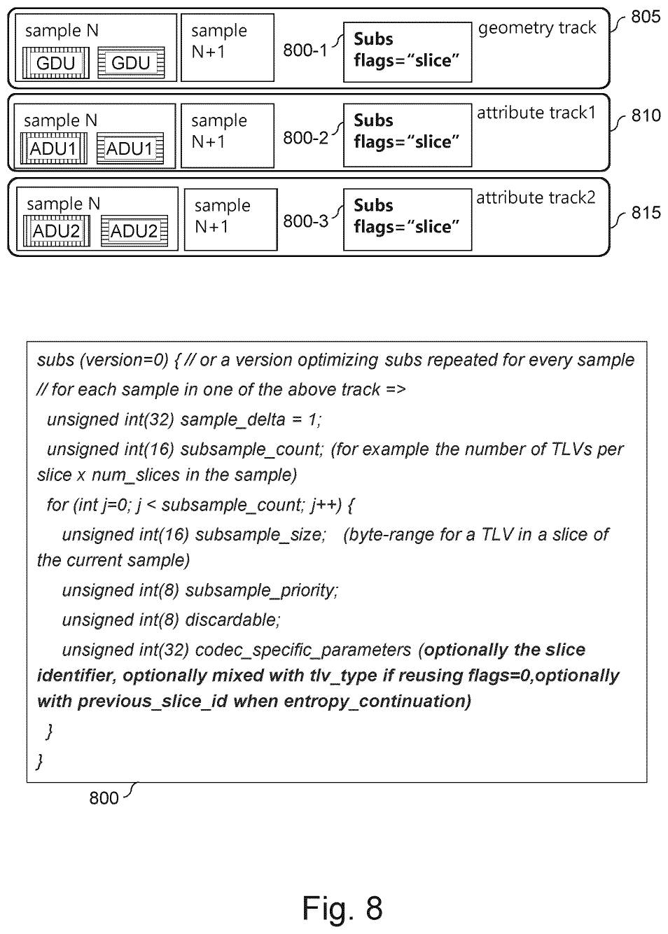

FIG. 8 illustrates an example of adding dynamic indication in a multi-track media file encapsulating slice-based point cloud frames to help a parser to reconstruct a bit-stream complying with a predetermined format, for example to reconstruct a G-PCC bit-stream.

According to this embodiment, a description of TLVs to slice mapping on a subsample basis is provided. To that end, the writer may use the ‘subs’ box from ISOBMFF, for example ‘subs’ box 800, with a specific flags value to indicate that subsamples here actually correspond to slices (this allows lighter description when some data units are duplicated). As illustrated with references 800-1 to 800-3, such a mapping may be provided for each track, for example for geometry track 805 and for attribute tracks 810 and 815. As an example, the flags value 0x000004 (in hexadecimal) is reserved to indicate that the sub-samples described in the ‘subs’ box of a G-PCC track are G-PCC slice-based sub-samples. For example, the value of the codec specific parameters field of the SubsampleInformationBox may be defined as below:

| if (flags == 0) { | |
|---|---|
| unsigned int(8) | payloadType; |
| if (payloadType == 4) { // attribute payload | |
| unsigned int(6) | attrIdx; |
| bit(18) | reserved = 0; |
| } | |
| else | |
| bit(24) | reserved = 0; |
| } else if (flags == 1) { | |
| unsigned int(1) | tile_data; |
| bit(7) | reserved = 0; |
| if (tile_data) | |
| unsigned int(24) | tile_id; |
| else | |
| bit(24) | reserved = 0; |
| } else if (flags = 0x000004) { // G-PCC slice-based sub- | |
| sample | |
| unsigned int(16) | slice_id; |
| unsigned int(16) | prev_slice_id; // optional |

}

where
slice_id provides the identifier of the slice identifier of the sub-sample and
prev_slice_id indicates the slice identifier of a previous slice onto which depends the sub-sample (the sub-sample may have no dependencies and then prev_slice_id is set to 0xFFFF, the default value to indicate that there is no previous slice onto which the subsample depends). The prev_slice_id parameter is optional and may be replaced by 16 reserved bits, set to value 0. It is not useful for bit-stream where entropy_continuation_enabled is indicated as not active in the SPS, i.e., when the entropy parsing of a data unit of the current slice does not depend upon the final entropy parsing state of a data unit in the preceding slice.

An existing flags value may also be reused, like value 0 indicating a TLV based (or G-PCC unit based) sub-sample. In this case, the codec_specific_parameters field of the SubsampleInformationBox may be defined as below:

| if (flags == 0) { | |
|---|---|
| unsigned int(8) | payloadType; |
| if (payloadType == 4 \|\| payloadType == 7) { // attribute | |
| payload | |
| unsigned int(6) | attrIdx; |
| bit(16) | slice_id; |
| bit(2) | reserved = 0; |
| } else if (payloadType == 2) { // geometry payload | |
| unsigned bit(16) | slice_id; |
| unsigned bit(8) | delta_prev_slice_id; |

} else {
bit (24) reserved = 0;
}
} // other flags values...

where slice_id provides the identifier of the sub-sample (TLV or G-PCC unit). Optionally, for GDU TLVs (when payloadType=2), an identifier of a previous slice is provided in the delta_prev_slice_id parameter, encoded as slice_id minus prev_slice_id to be represented on the 8 remaining bits of the codec specific parameters. It is to be noted that the sub-sample may have no dependencies and then delta_prev_slice_id is set to 0xFFFF, the default value to indicate that there is no previous slice onto which the sub-sample depends. In a variant without indication of a possible identifier for a previous slice, the 8 remaining bits are simply reserved and set to 0.

The slice identifier may be provided in the codec_specific_parameter, for example on 16 bits. Optionally the previous_slice_id may be present (when entropy continuation is activated, possibly encoded as a delta to slice_id on 8 bits, if bits are needed for other parameters). In some variants, especially for a flags value of subs dedicated to slices, the slice identifier may even be omitted and the codec_specific_parameters may be equal to 0. Parser should then deduce that the corresponding subsample size corresponds to one slice and the next subsample size will correspond to the next slice (this does guarantee increasing order or compliance with the entropy continuation). This is why ‘subs’ with a dedicated flags value may be safer. Reusing value 0 would also require to change the properties of the component tracks to allow them to contain ‘subs’ boxes with flags value set to 0 which is not allowed in current version of the ISO/IEC 23090-18 specification (Oct. 2021, 13). To avoid the issues about flags values, ‘subs’ box 800 may be authorized in the GPCCComponentInfoBox as an optional box. The metadata structure 800 may be generated by the writer during step 545 in FIG. 5.

Since these additional indications may be specified for many samples in a sequence, the writer may use an optimized version of the ‘subs’ box, if available, or a zipped or deflate version, possibly indicated with a specific 4 cc. Then, when a parser wants to use subs information, it has first to unzip or uncompress this version of the ‘subs’ box to obtain the actual subsample sizes and offsets in the media data part.

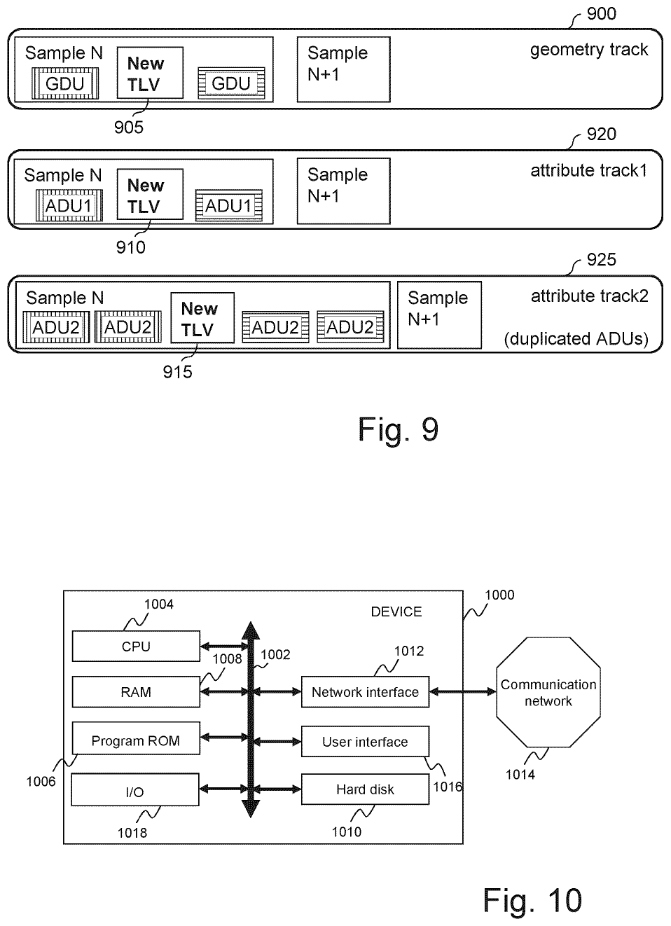

FIG. 9 illustrates an example of adding slice separators in a multi-track media file encapsulating slice-based point cloud frames to help a parser to reconstruct a bit-stream complying with a predetermined format, for example to reconstruct a G-PCC bit-stream.

According to this embodiment, a specific TLV unit acting as a separator is added within the media data part of the file (for example in ‘mdat box). Such separators may be added in each track (i.e. in the geometry track and the attribute tracks) by the writer when it detects that a slice has been read (this can be detected by comparing first bytes of data units of a same type, or by decoding the first 3 bytes of a data unit possibly containing a slice identifier like a GDU, an ADU, or a defaulted attribute data unit). As illustrated in FIG. 9, new TLV unit 905 is positioned between GDUs of two different slices within geometry track 900. Likewise, new TLV units 910 and 915 are positioned between ADUs of two different slices within attributes tracks 920 and 925, respectively. The bytes for these separator TLVs may be considered when computing sample sizes and sample or chunk offsets in the media part of the file.

These TLV units are used by a parser to identify data units from a slice from data units from another slice, making it possible to order the data units properly. When a parser encounters such TLV units in a media data part of a media file, it should interpret and then discard these TLV units. In other words, parsers should not include these separator TLVs in the reconstructed bit-stream. It is observed that such a TLV unit may not be needed after the last slice of a sample (because the parser may detect the end of a sample as an end of the last slice).

According to a particular embodiment, this specific TLV unit just contains a TLV type and an empty payload:

| | |
|---|---|
| tlv_encapsulation( ) { | (slice separator TLV) |

```
  unsigned int (8) tlv_type = 0xFF; (or any value reserved for
this usage and not already in use)
  unsigned int (32) tlv_num_payload_bytes = 0;
    // no payload
}
```

In a variant, the slice identifier of the preceding data units may be provided as payload of the slice separator TLV. The tlv_num_payload_bytes is then set to 2 (bytes) and the value of the slice identifier follows. When entropy continuation is activated, the prev_slice_id may also be provided, allowing the parser to do deeper checks (without decoding the GDU or ADU headers). In this case, the tlv_num_payload_bytes may be set to 4 (bytes) and the value of the slice identifier follows on 2 bytes as well as the value of the prev_slice_id on 2 bytes.

This specific TLV unit may be defined and used only at Systems level between writers and parsers. A G-PCC encoder may not need to generate this kind of separator and a G-PCC decoder may not understand it.

Optionally, there may also be delimiters for slice sets and for repeated slices to easily allow parser not to include it in the reconstructed bit-stream. They can be defined as the slice separator, with a specific tlv_type and no payload. Likewise, there may be delimiters between slices having the same slice_tag value. A parser can then check that they provide data for a given slice tag as a contiguous byte range to decoders.

### Tiled Slice-Based Point Cloud Frames

It is observed that handling tiled slice-based point cloud frames is similar to handling slice-based point cloud frames that are not tiled, the process explained herein above being applied for each tile. However, it is observed here that there exist some configurations for tile tracks wherein the geometry and attribute tracks are split so that some tiles are organized according to the process explained herein above and some tiles are not organized according to this process (for example if the latter contain only one slice).

### Hardware for Carrying Out Steps of Some Embodiments of the Disclosure

FIG. 10 is a schematic block diagram of a computing device 1000 for implementation of one or more embodiments of the disclosure. The computing device 1000 may be a device such as a micro-computer, a workstation, or a light portable device. The computing device 1000 comprises a communication bus 1002 connected to:
a central processing unit (CPU) 1004, such as a microprocessor;
a random access memory (RAM) 1008 for storing the executable code of the method of embodiments of the disclosure as well as the registers adapted to record variables and parameters necessary for implementing the method for encapsulating, indexing, de-encapsulating, and/or accessing data, the memory capacity thereof can be expanded by an optional RAM connected to an expansion port for example;
a read only memory (ROM) 1006 for storing computer programs for implementing embodiments of the disclosure;
a network interface 1012 that is, in turn, typically connected to a communication network 1014 over which digital data to be processed are transmitted or received. The network interface 1012 can be a single network interface, or composed of a set of different network interfaces (for instance wired and wireless interfaces, or different kinds of wired or wireless interfaces). Data are written to the network interface for transmission or are read from the network interface for reception under the control of the software application running in the CPU 1004;
a user interface (UI) 1016 for receiving inputs from a user or to display information to a user;
a hard disk (HD) 1010; and/or
an I/O module 1018 for receiving/sending data from/to external devices such as a video source or display.

The executable code may be stored either in read only memory 1006, on the hard disk 1010 or on a removable digital medium for example such as a disk. According to a variant, the executable code of the programs can be received by means of a communication network, via the network interface 1012, in order to be stored in one of the storage means of the communication device 1000, such as the hard disk 1010, before being executed.

The central processing unit 1004 is adapted to control and direct the execution of the instructions or portions of software code of the program or programs according to embodiments of the disclosure, which instructions are stored in one of the aforementioned storage means. After powering on, the CPU 1004 is capable of executing instructions from main RAM memory 1008 relating to a software application after those instructions have been loaded from the program ROM 1006 or the hard-disc (HD) 1010 for example. Such a software application, when executed by the CPU 1004, causes the steps of the flowcharts shown in the previous figures to be performed.

In this embodiment, the apparatus is a programmable apparatus which uses software to implement the method of the disclosure. However, alternatively, the method of the present disclosure may be implemented in hardware (for example, in the form of an Application Specific Integrated Circuit or ASIC).

Although the present disclosure has been described hereinabove with reference to specific embodiments, the present disclosure is not limited to the specific embodiments, and modifications will be apparent to a person skilled in the art which lie within the scope of the present disclosure.

Many further modifications and variations will suggest themselves to those versed in the art upon making reference to the foregoing illustrative embodiments, which are given by way of example only and which are not intended to limit the scope of the disclosure, that being determined solely by the appended claims. In particular the different features from different embodiments may be interchanged, where appropriate.

In the claims, the word “comprising” does not exclude other elements or steps, and the indefinite article “a” or “an” does not exclude a plurality. The mere fact that different features are recited in mutually different dependent claims does not indicate that a combination of these features cannot be advantageously used.

1. A method of encapsulating a bit-stream in a media file comprising different tracks, the bit-stream comprising point cloud data, the point cloud data comprising slice-based frames, the slices of the frames comprising data units of different types, the method comprising:
obtaining first data units of a first slice of one frame;
for each of the obtained first data units, encapsulating the first data unit in a track of the media file, the track being selected as a function of a type of the first data unit;
obtaining second data units of a second slice of the frame;
for each of the obtained second data units, encapsulating the second data unit in a track of the media file, the track being selected as a function of a type of the second data unit;
obtaining at least one item of information characterizing the relative order, in a sample of a track, of a data unit of the first slice with regard to a data unit of the second slice; and
encapsulating the obtained at least one item of information in the media file.

2. The method of claim 1, wherein at least one of the obtained at least one item of information is encapsulated in a first track of the different tracks of the media file as a sample group.

3. The method of claim 1, wherein at least one of the obtained at least one item of information is encapsulated in each track of the different tracks of the media file.

4. The method of claim 3, wherein the at least one item of information encapsulated in each track of the different tracks of the media file is a slice separator.

5. The method of claim 1, wherein the at least one item of information comprises description of a structure of data units within a sample, each data unit being associated with slice information.

6. (canceled)

7. The method of claim 1, wherein the media file complies with an ISOBMF format.

8. A method of parsing a media file comprising encapsulated point cloud data, the point cloud data comprising slice-based frames, the slices of the frames comprising data units of different types, the data units being encapsulated in the media file in different tracks as a function of their type, the method comprising:
obtaining, from the media file, at least one item of information characterizing the relative order, in a sample of a track, of a data unit belonging to a first slice with regard to a data unit belonging to a second slice,
obtaining a first set of at least one first data unit from a first track of the different tracks based on the at least one item of information, the data units of the first set belonging to the first slice;
obtaining a second set of at least one second data unit from a second track of the different tracks based on the at least one item of information, the second track being different from the first track and the data units of the second set belonging to the first slice, and
concatenating the data units of the first set and the data units of the second set so that the data units of the first set and the data units of the second set are contiguous.

9. (canceled)

10. The method of claim 8, further comprising obtaining a third set of at least one third data unit from the first track based on the at least one item of information, the data units of the third set belonging to the second slice, the second slice being different from the first slice and following the first slice, the data units of the first set and the data units of the third set belonging to a same sample, the data units of the third set being concatenated after the data units of the first set and the data units of the second set in the generated bit-stream.

11-15. (canceled)

16. The method of claim 8, wherein the media file complies with an ISOBMF format.

17. A non-transitory computer-readable storage medium storing an information dataset for media data, the information dataset comprising encoded media data encapsulated according to the method of claim 1.

18. A non-transitory computer-readable storage medium storing computer-executable instructions for implementing each of the steps of the method according to claim 8.

19. A non-transitory computer-readable storage medium storing computer-executable instructions for implementing each of the steps of the method according to claim 1.

20. A device comprising:
at least one processor; and
at least one memory that is in communication with the at least one processor, wherein the at least one memory stores instructions for causing the at least one processor and the at least one memory to:
obtain first data units of a first slice of one frame of a bit-stream in a media file comprising different tracks, the bit-stream comprising point cloud data, the point cloud data comprising slice-based frames, the slices of the frames comprising data units of different types;
for each of the obtained first data units, encapsulate the first data unit in a track of the media file, the track being selected as a function of a type of the first data unit;
obtain second data units of a second slice of the frame;
for each of the obtained second data units, encapsulate the second data unit in a track of the media file, the track being selected as a function of a type of the second data unit;
obtain at least one item of information characterizing the relative order, in a sample of a track, of a data unit of the first slice with reward to a data unit of the second slice; and
encapsulate the obtained at least one item of information in the media file.

21. The method of claim 2, wherein the first track has a reference to the other tracks of the different tracks and the at least one item of information comprises a number of consecutive data units, for each slice in a sample, for the first track and for the referenced tracks.

22. The method of claim 21, wherein the at least one item of information further comprises the number of slices in the sample.

23. The method of claim 2, wherein the first track is of type geometry and the other tracks of the different tracks are of type attribute.

24. The method of claim 8, wherein at least one of the obtained at least one item of information is encapsulated in the first track of the media file as a sample group.

25. The method of claim 8, wherein the at least one item of information is a slice separator.

26. The method of claim 8, wherein the first track has a reference to the other tracks of the different tracks and the at least one item of information comprises a number of consecutive data units for each slice in a sample for the first track and for the referenced tracks.

27. The method of claim 8, wherein the first track has a type indicating a geometry track and the other tracks of the different tracks have a type indicating attribute tracks.
